(19) United States
(12) Patent Application Publication
(10) Pub. No.: US 2026/0129369 A1
(43) Pub. Date: May 7, 2026

(54) VIBRATION ASSEMBLY AND LOUDSPEAKER

(71) Applicant: MERRY ELECTRONICS (SUZHOU) CO., LTD., Jiangsu Province (CN)

(72) Inventors: Huaming Wan, Jiangsu Province (CN); Mingya Luo, Jiangsu Province (CN); Xiaoxiang Wei, Jiangsu Province (CN)

(73) Assignee: MERRY ELECTRONICS (SUZHOU) CO., LTD., Jiangsu Province (CN)

(21) Appl. No.: 19/363,945

(22) Filed: Oct. 21, 2025

(30) Foreign Application Priority Data
Nov. 1, 2024 (CN) 202411554120.6

(51) Int. Cl. H04R 9/06; H04R 7/04; H04R 7/18; H04R 9/02; H04R 9/04

(52) U.S. Cl. CPC H04R 9/06; H04R 7/04; H04R 7/18; H04R 9/022; H04R 9/025; H04R 9/045

(57) ABSTRACT

A vibration assembly and a loudspeaker are provided. The vibration assembly includes a yoke structure, a diaphragm, a magnet member, and a voice coil. The yoke structure includes a plurality of first magnetic conductive layers and a plurality of first through holes. The diaphragm is arranged at a top end of the yoke structure. The magnet member is arranged at a bottom of a cavity formed by the diaphragm and the yoke structure, and an annular magnetic gap is between the magnet member and the yoke structure. The voice coil is arranged in the magnetic gap and connected to the diaphragm.

### CROSS-REFERENCE TO RELATED APPLICATION

This application claims the benefit of Chinese Patent Application No. 202411554120.6, filed on Nov. 1, 2024, entitled “Vibration assembly and Loudspeaker”, which is incorporated herein by reference in its entirety.

### FIELD

The present disclosure relates to the technical field of audio equipment, and particularly relates to a vibration assembly and a loudspeaker.

### BACKGROUND

In a vibration assembly of an existing loudspeaker, a yoke is generally provided with a vent hole for adjusting internal pressure, so as to achieve a better sound production effect. In order to avoid influence of water and dust on internal sensitive assemblies and adjust and improve acoustic performance, a nylon mesh cloth is commonly used for covering the vent hole to isolate an inner cavity from an outside. However, the nylon mesh cloth is soft. When too large a nylon mesh cloth is used, acoustic resonance easily occurs. Thus, for a larger vent hole, a metal mesh cloth is used for replacing the nylon mesh cloth and is attached to the vent hole. With wide use of loudspeakers, mounting spaces of vibration assemblies have been gradually decreased. In this case, the design with a single vent hole can hardly improve a heat dissipation effect. In addition, a mounting process is more complicated because of operations of additionally providing vent holes and attaching meshes.

### SUMMARY

The present disclosure provides a vibration assembly and a loudspeaker.

In one aspect, embodiments of the present disclosure provide a vibration assembly. The vibration assembly includes: a yoke structure, a diaphragm, a magnet member, and a voice coil.

The yoke structure includes a plurality of nested first magnetic conductive layers, and each of the first magnetic conductive layers includes a bowl-shaped part and a connection part. The connection part is arranged at a top end of the bowl-shaped part and extends laterally outward to form an annular edge. The yoke structure is provided with a plurality of first through holes, and each of the first through holes penetrates the bowl-shaped parts of the plurality of first magnetic conductive layers.

The diaphragm is arranged at a top end of the yoke structure, and an edge of the diaphragm is connected to the connection part. The diaphragm and the yoke structure define a cavity.

The magnet member is arranged at a bottom of the cavity, and an annular magnetic gap is formed between a side surface of the magnet member and the yoke structure.

The voice coil is arranged in the annular magnetic gap, and a top end of the voice coil is connected to the diaphragm.

In some embodiments, sizes of the plurality of first magnetic conductive layers increase from inside to outside sequentially. The plurality of first through holes are provided on the bowl-shaped parts in a matrix form.

In some embodiments, the yoke structure further includes a second magnetic conductive layer. The second magnetic conductive layer has a bowl-shaped structure and is attached to an outer surface of the bowl-shaped part of the outermost first magnetic conductive layer. The second magnetic conductive layer is provided with a plurality of second through holes corresponding to the plurality of first through holes.

In some embodiments, the yoke structure is provided with relief grooves. The relief grooves penetrate the connection parts of the plurality of first magnetic conductive layers and enable an outside of the yoke structure to be in communication with the cavity.

In some embodiments, two sides of the voice coil are connected to wires, and the wires extend through the relief grooves.

In some embodiments, the vibration assembly further includes a circuit board assembly. The circuit board assembly is arranged below the yoke structure and electrically connected to the wires.

In some embodiments, the vibration assembly further includes support structures. The support structures are arranged at the outer side of the yoke structure. Tops of the support structures extend into the relief grooves. Bottoms of the support structures are connected to the circuit board assembly. Channels for accommodating the wires are provided inside the support structures.

In some embodiments, the magnet member includes a central magnet and a magnetic conductive sheet. The magnetic conductive sheet is arranged at a top end of the central magnet.

In some embodiments, the vibration assembly further includes a bonding layer. The diaphragm is connected to the connection parts through the bonding layer.

In another aspect, embodiments of the present disclosure provide a loudspeaker. The loudspeaker includes the above vibration assembly.

### BRIEF DESCRIPTION OF DRAWINGS

With reference to the following description of accompanying drawings on examples of the present disclosure, the above and other objectives, features and advantages of the present disclosure will become more apparent. In the drawings:

FIG. 1 is a top perspective view of a vibration assembly of an example of the present disclosure;

FIG. 2 is a bottom perspective view of a vibration assembly of an embodiment of the present disclosure;

FIG. 3 is an exploded view of a vibration assembly of an embodiment of the present disclosure;

FIG. 4 is a sectional view of a vibration assembly of an embodiment of the present disclosure;

FIG. 5 is an enlarged local view of a yoke structure of an embodiment of the present disclosure;

FIG. 6 is a top perspective view of a vibration assembly of an embodiment of the present disclosure with a diaphragm removed;

FIG. 7 is a top perspective view of a vibration assembly of an embodiment of the present disclosure with a diaphragm and a bonding layer removed; and

FIG. 8 is a perspective view of a vibration assembly of an embodiment of the present disclosure with a diaphragm, a bonding layer and support structures removed.

### DESCRIPTION OF REFERENCE NUMERALS

1—yoke structure; 11—first magnetic conductive layer; 111—bowl-shaped part; 112—connection part; 12—first through hole; 13—relief groove; 14—second magnetic conductive layer; 15—second through hole; 2—diaphragm; 3—magnet member; 31—central magnet; 32—magnetic conductive sheet; 4—voice coil; 5—bonding layer; 6—wire; 7—circuit board assembly; 8—support structure; 81—channel.

### DETAILED DESCRIPTION OF THE EMBODIMENTS

The present disclosure will be described below based on examples, and the present disclosure is not limited to the examples. Some specific details will be described in detail in the following detailed description of the present disclosure. For those skilled in the art, the present disclosure can be fully understood without the description of these details. In order to avoid confusion of the essence of the present disclosure, well-known methods, processes, flows, elements and circuits are not described in detail.

In addition, it should be understood by those of ordinary skill in the art that the drawings provided herein are used for illustration and are not necessarily drawn to scale.

Unless expressly specified and defined otherwise, the terms “mount”, “connect”, “connection” and “fix” are to be construed broadly. For instance, they can denote fixed connection, detachable connection or integral connection, denote mechanical connection or electrical connection, denote direct connection or indirect connection through an intermediate medium, or denote communication between interiors of two elements or interaction between two elements, unless expressly defined otherwise. For those of ordinary skill in the art, specific meanings of the above terms in the present disclosure can be understood according to specific circumstances.

For ease of description, space-related terms such as “inside”, “outside”, “under”, “below”, “lower portion”, “above” and “upper portion” are used herein for describing a relationship between one element or feature and another element or feature illustrated in the drawings. It is to be understood that the space-related terms may be intended to encompass different orientations of an apparatus in use or operation except orientations depicted in the drawings. For instance, if the apparatus in the drawings is reversed, an element described as being “below” or “under” another element or feature will be oriented as “above” another element or feature. Thus, the illustrative term “below” can include two orientations of above and below. The apparatus may be oriented in another manner (rotated by 90 degrees or at another orientation), and space-related descriptors used herein should be explained accordingly.

Unless expressly defined otherwise, “include”, “comprise” and other similar words in the entire application document should be interpreted as inclusive rather than exclusive or exhaustive, which mean “including but not limited to”.

In the description of the present disclosure, it should be understood that the terms such as “first” and “second” are merely used for description, and cannot be understood as indicating or implying relative importance. In addition, in the description of the present disclosure, “plurality” means two or more, unless otherwise specified.

A loudspeaker is an electro-acoustic transducer, and generally includes a vibration assembly including a magnet, a coil, and a diaphragm. The coil is connected to the diaphragm and arranged in a magnetic field of the magnet. After an alternating current is introduced into the coil, mobile charges are subjected to a Lorentz force in the magnetic field. From a macro perspective, the coil vibrates under action of a periodic ampere force, and further drives the diaphragm to vibrate. Vibration of the diaphragm makes air compress and vibrate, forming a sound wave having a consistent frequency to produce sound, and implementing transformation from electric signals to sound.

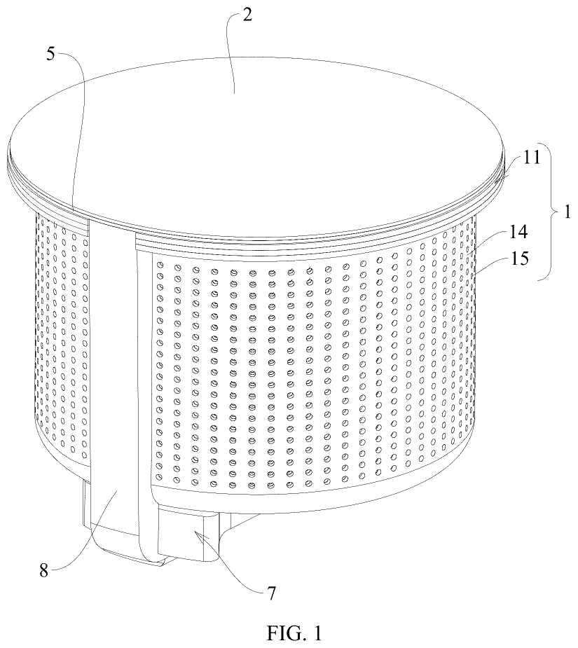

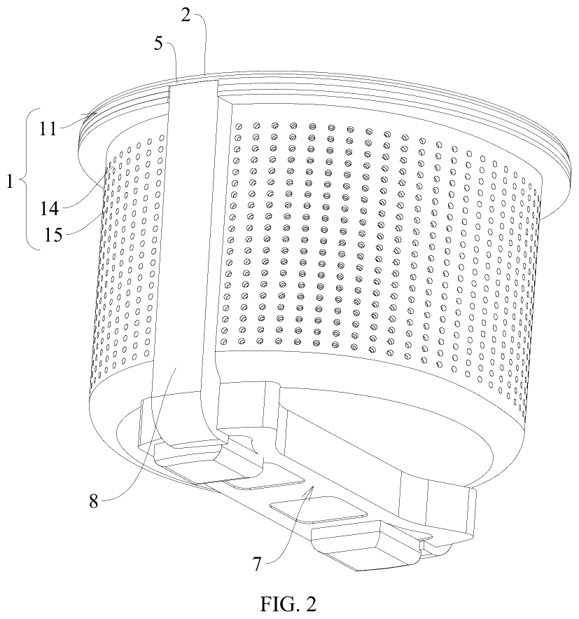

With reference to FIG. 1, and FIG. 2 to FIG. 4, a vibration assembly includes a yoke structure 1, a diaphragm 2, a magnet member 3, and a voice coil 4. The yoke structure 1 is configured to support the entire vibration assembly and enable an inside of the vibration assembly and outside air to be in communication, so as to implement heat dissipation and pressure adjustment. Meanwhile, the yoke structure 1 cooperates with the magnet member 3 to form a closed magnetic loop and shield interference of an external magnetic field on an internal magnetic field. The diaphragm 2 is arranged at a top end of the yoke structure 1. An edge of the diaphragm is connected to the yoke structure 1. The diaphragm and the yoke structure jointly form a cavity. A lower end of the diaphragm 2 is connected to the voice coil 4. The diaphragm vibrates along with the voice coil 4 to produce sound. The magnet member 3 is arranged at a bottom of the cavity. An annular magnetic gap is formed between a side surface of the magnet member and the yoke structure 1. The voice coil 4 is arranged in the annular magnetic gap. Two sides of the voice coil are connected to wires 6. The wires 6 are used for introducing currents into the voice coil 4. Once a current is introduced into the voice coil 4, the voice coil 4 vibrates in the magnetic gap, and drives the diaphragm 2 to vibrate and produce sound.

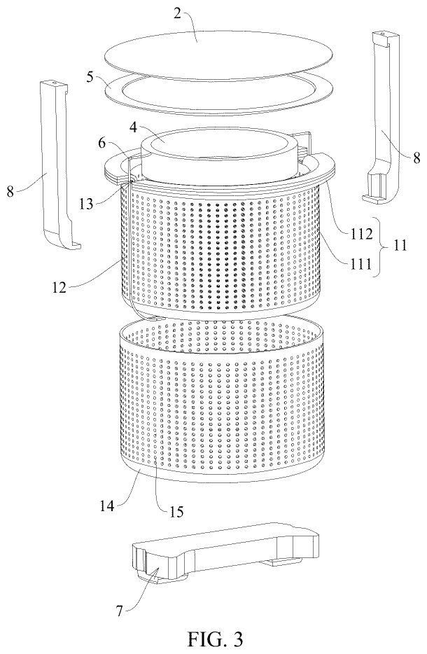

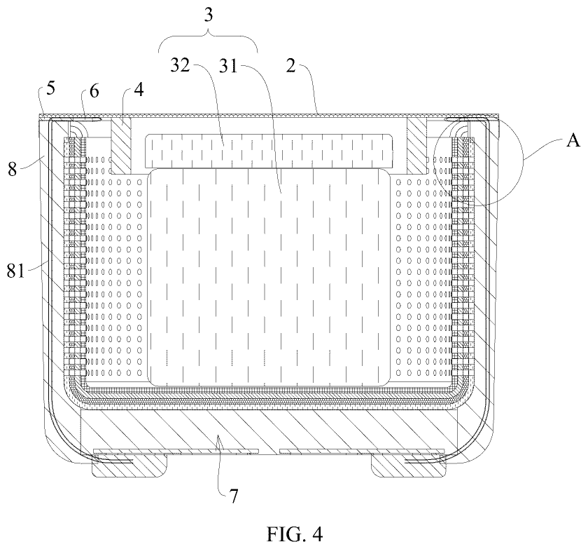

With reference to FIG. 3 to FIG. 4, the yoke structure 1 includes a plurality of nested first magnetic conductive layers 11. Each of the first magnetic conductive layers 11 has a small thickness. Thus, in order to improve structural strength and magnetic field strength, it is necessary to stack the plurality of first magnetic conductive layers 11. According to a use scene and mounting space of the vibration assembly, a thickness of a signal layer of the first magnetic conductive layer and a number of the first magnetic conductive layers 11 may be adjusted to achieve an optimal product effect. Each of the first magnetic conductive layers 11 includes a bowl-shaped part 111 and a connection part 112. For example, an inner surface of the bowl-shaped part 111 of an outer first magnetic conductive layer 11 is in contact with an outer surface of the bowl-shaped part 111 of an inner first magnetic conductive layer 11. The connection part 112 is arranged at a top end of the bowl-shaped part 111 and extends laterally outward to form an annular edge. The bowl-shaped parts 111 are configured to form the cavity and accommodate an internal structure of the vibration assembly. The connection parts 112 are configured to enable contact and connection between the yoke structure 1 and other structures. The first magnetic conductive layers 11 are made of soft magnetic materials, such as ferrite and silicon-steel sheets. According to an actual situation, when the plurality of first magnetic conductive layers 11 are nested, the plurality of soft magnetic material layers are stacked and stamped together to form the yoke structure 1 having the bowl-shaped parts 111 and the connection parts 112. As a nested structure is formed through one-time stamping of a plurality of layers, sizes of the plurality of first magnetic conductive layers 11 increase from inside to outside sequentially. Each of the first magnetic conductive layers 11 is closely attached to the adjacent first magnetic conductive layer 11 without sliding. That is, when the diaphragm 2 is connected to the connection part 112 of the topmost first magnetic conductive layer 11, the first magnetic conductive layers 11 outside the topmost first magnetic conductive layer do not fall off layer by layer and do not loss connection, and are tightly fixed together. The plurality of first magnetic conductive layers 11 are attached to form the yoke structure 1. The yoke structure of the present disclosure replaces a yoke in the prior art to achieve supporting and magnetic conduction functions. While satisfying required rigidity requirements and magnetic field strength requirements, the yoke structure 1 enables the vibration assembly to adapt to more use scenes, and flexibly adjusts a number of the first magnetic conductive layers and a thickness of the first magnetic conductive layers according to different use scenes. In this way, product adaptability is improved.

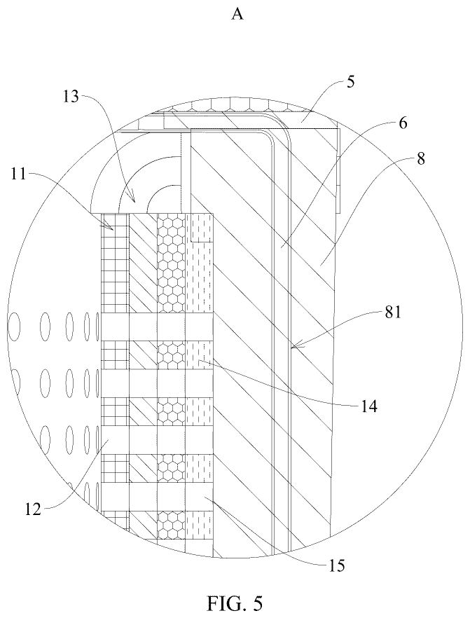

FIG. 4 is a sectional view of a vibration assembly of an embodiment of the present disclosure. FIG. 5 is an enlarged local view of part A of the yoke structure in FIG. 4. With reference to FIG. 3 to FIG. 5, the yoke structure 1 is provided with a plurality of first through holes 12. The plurality of first through holes 12 are provided on the bowl-shaped parts 111 in a matrix form. Each of the first through holes 12 penetrates the bowl-shaped parts 111 of the plurality of first magnetic conductive layers 11. A side surface of each of the first magnetic conductive layers 11 is provided with a plurality of holes arranged in a matrix form. According to an actual situation, the holes may be formed before one-time stamping or after stamping is completed. When the holes are formed before one-time stamping, materials of different layers may be deformed in the stamping process, causing that the holes in each of the first magnetic conductive layers 11 are offset after stamping. The first through holes 12 are through holes finally formed by the holes of the plurality of first magnetic conductive layers 11. In this case, an area of the first through holes 12 is smaller than that of the holes before stamping. When the holes are formed after stamping, a shape of the yoke structure 1 is formed first, the holes in each of the first magnetic conductive layers 11 are penetrative, and the holes at a same position of all the first magnetic conductive layers 11 together form one first through hole 12. In this case, an area of the first through holes 12 is equal to that of the holes after stamping. The holes are directly formed in the yoke structure 1, such that problems that a single vent hole occupies a yoke space and reduces local rigidity strength and magnetic field strength of the yoke structure in the prior art are avoided. Further, a better heat dissipation effect can be achieved, such that a complicated structure with a single vent hole formed and a nylon mesh cloth or metal mesh cloth attached is effectively omitted, and product working efficiency is enhanced. Meanwhile, the stacking of the first magnetic conductive layers 11 of the yoke structure 1 can achieve required magnetic field strength, so the first through holes 12 basically have no great influence on the magnetic field strength of the yoke structure 1.

In some embodiments, with reference to FIG. 3, the yoke structure 1 further includes a second magnetic conductive layer 14. The second magnetic conductive layer 14 has a bowl-shaped structure and is attached to an outer surface of the bowl-shaped part 111 of the outermost first magnetic conductive layer 11. A top end of the bowl-shaped structure of the second magnetic conductive layer 14 is opened and is not provided with extending connection structure. The top end of the bowl-shaped structure of the second magnetic conductive layer 14 is in contact with bottom surface of the connection part 112 of the outermost first magnetic conductive layer 11. The second magnetic conductive layer 14 is provided with second through holes 15 corresponding to the plurality of first through holes 12. The second through hole 15 is in communication with the corresponding first through hole 12. The first through holes 12 and the second through holes 15 are penetrative, such that air outside of the vibration assembly is in communication with the cavity. The cavity can dissipate heat through the first through holes 12 and the second through holes 15, and air pressure can be adjusted. In this way, a heat dissipation effect is improved, a complicated structure is omitted, and product working efficiency is enhanced.

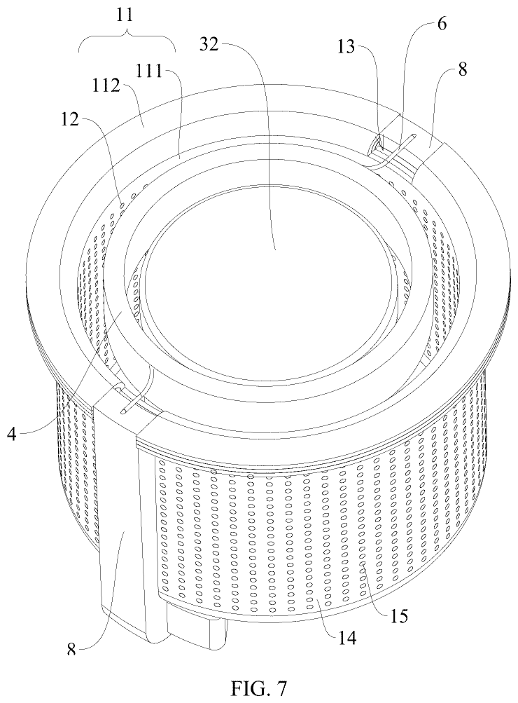

In some embodiments, the yoke structure 1 is provided with relief grooves 13, as shown in FIG. 3 to FIG. 5 and FIG. 7. The relief grooves 13 are configured to allow the wires 6 and other components that need to pass through the yoke structure 1 to pass. The relief grooves 13 penetrate the connection parts 112 of the plurality of first magnetic conductive layers 11. According to an actual situation, the plurality of connection parts 112 extend laterally and are stacked to have a certain thickness, so the relief grooves 13 forms openings having a certain height. The relief grooves 13 enable an outside of the yoke structure 1 to be in communication with the cavity, and the wires 6 arranged on the two sides of the voice coil 4 extend out through the relief grooves 13. In this way, the vibration assembly has a more compact structure, space occupation is reduced, and mounting requirements in various situations can be better satisfied.

In some embodiments, with reference to FIG. 4, the magnet member 3 includes a central magnet 31 and a magnetic conductive sheet 32. The magnetic conductive sheet 32 is arranged at a top end of the central magnet 31 to facilitate concentration and guiding of the magnetic field and improve performance of the vibration assembly. The magnet member 3 cooperates with the yoke structure 1 to form a closed magnetic loop, and shields interference of the external magnetic field to ensure concentration of the magnetic field in the vibration assembly. Thus, the vibration assembly can vibrate stably and satisfy mounting requirements in various situations.

In some embodiments, the vibration assembly further includes a circuit board assembly 7 and one or more support structures 8, as shown in FIG. 1 and FIG. 5. The circuit board assembly 7 is arranged below the yoke structure 1 and electrically connected to the wires 6. The circuit board assembly 7 provides an electrical signal to the voice coil 4. In this way, the voice coil can vibrate, and drive the diaphragm 2 to vibrate, so as to drive the vibration assembly to work. The support structures 8 are arranged at the outer side of the yoke structure 1 so as to externally support the yoke structure 1. According to an actual situation, the support structure 8 may be a longitudinal supporting structure or other supporting structures. The support structures are symmetrically mounted outside the yoke structure 1 or mounted in a circumferential direction. Tops of the support structures 8 extend into the relief grooves 13, and bottoms of the support structures are connected to the circuit board assembly 7. Channels 81 for accommodating the wires 6 are provided inside the support structures 8, such that the wires 6 outside the yoke structure 1 are protected.

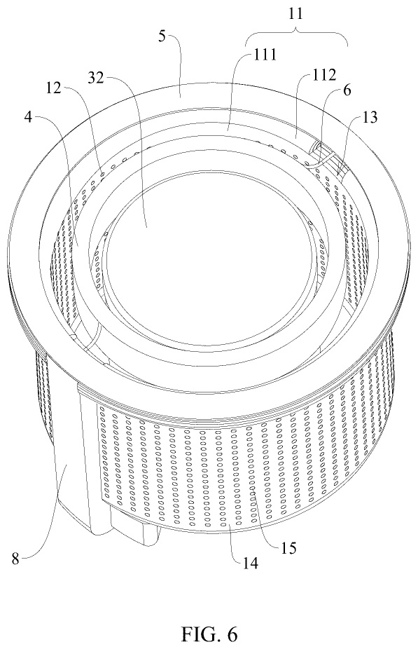

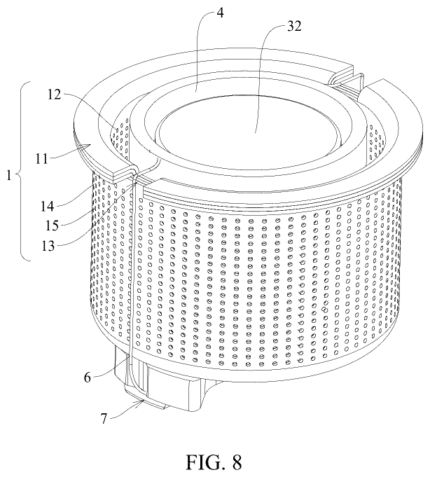

In some embodiments, with reference to FIG. 6 to FIG. 8, the vibration assembly further includes a bonding layer 5. The bonding layer is arranged between the edge of the diaphragm 2 and the connection part 112 and is configured to connect the diaphragm 2 to the connection part 112. According to an actual situation, the bonding layer 5 may be set as a closed annular structure. For part of the connection part 112 where the relief groove 13 is formed, an upper end surface of the bonding layer 5 is connected to the diaphragm 2, and a lower end surface of the bonding layer is in contact with top surface of the support structure 8. The bonding layer 5 allows the wires 6 to pass. In this way, the wires 6, the support structures 8, the yoke structure 1 and an edge part of the diaphragm 2 can be fixed, structural strength is enhanced, and stability of the vibration assembly is ensured.

With reference to FIG. 1, the loudspeaker of an embodiment of the present disclosure includes the vibration assembly described above. According to actual situations and product requirements, other structures may be additionally mounted outside the vibration assembly, a complete loudspeaker may be formed through conventional processes, and sound production quality is improved. For instance, an external case is added to better protect and support the vibration assembly and improve sound output characteristics. Connecting an external operation panel facilitates user operations and sound production effect adjustment. Coating with a damping material reduces reflection and standing waves in a sound production process and improve sound quality.

Embodiments of the present disclosure provide the vibration assembly and the loudspeaker. The vibration assembly includes the yoke structure, the diaphragm, the magnet member, and the voice coil. The yoke structure includes the plurality of nested first magnetic conductive layers and the plurality of first through holes. The diaphragm is arranged at the top end of the yoke structure. The magnet member is arranged at the bottom of the cavity formed by the diaphragm and the yoke structure, and forms the annular magnetic gap with the yoke structure. The voice coil is arranged in the magnetic gap and connected to the diaphragm. The plurality of first magnetic conductive layers are nested to form the yoke structure, and are provided with the plurality of first through holes. The multi-layer yoke structure replaces an original yoke to achieve supporting and magnetic conduction functions, and a multi-hole arrangement replaces an original design of a single vent hole in cooperation with a metal mesh cloth. Thus, a heat dissipation effect is improved, a complicated structure is omitted, and product working efficiency is enhanced.

What are described above are merely examples of the present disclosure and are not intended to limit the present disclosure. Various changes and modifications can be made to the present disclosure by those skilled in the art. Any modifications, equivalent substitutions, improvements, etc. made within the spirit and principle of the present disclosure should fall within the protection scope of the present disclosure.

What is claimed is:

1. A vibration assembly, comprising:
a yoke structure, comprising a plurality of nested first magnetic conductive layers, wherein each of the first magnetic conductive layers comprises a bowl-shaped part and a connection part, the connection part is arranged at a top end of the bowl-shaped part and extends laterally outward to form an annular edge, the yoke structure is provided with a plurality of first through holes, and each of the first through holes penetrates the bowl-shaped parts of the plurality of first magnetic conductive layers;
a diaphragm, arranged at a top end of the yoke structure, wherein an edge of the diaphragm is connected to the connection part, and the diaphragm and the yoke structure define a cavity;
a magnet member, arranged at a bottom of the cavity, wherein an annular magnetic gap is formed between a side surface of the magnet member and the yoke structure; and
a voice coil, arranged in the annular magnetic gap, wherein a top end of the voice coil is connected to the diaphragm.

2. The vibration assembly according to claim 1, wherein sizes of the plurality of first magnetic conductive layers increase from inside to outside sequentially, and the plurality of first through holes are provided on the bowl-shaped parts in a matrix form.

3. The vibration assembly according to claim 1, wherein the yoke structure further comprises a second magnetic conductive layer, the second magnetic conductive layer has a bowl-shaped structure and is attached to an outer surface of the bowl-shaped part of the outermost first magnetic conductive layer, and the second magnetic conductive layer is provided with a plurality of second through holes corresponding to the plurality of first through holes.

4. The vibration assembly according to claim 1, wherein the yoke structure is provided with relief grooves, and the relief grooves penetrate the connection parts of the plurality of first magnetic conductive layers and enable an outside of the yoke structure to be in communication with the cavity.

5. The vibration assembly according to claim 4, wherein two sides of the voice coil are connected to wires, and the wires extend through the relief grooves.

6. The vibration assembly according to claim 5, further comprising a circuit board assembly that is arranged below the yoke structure and electrically connected to the wires.

7. The vibration assembly according to claim 6, further comprising support structures, wherein the support structures are arranged outside of the yoke structure, tops of the support structures extend into the relief grooves, bottoms of the support structures are connected to the circuit board assembly, and channels for accommodating the wires are provided inside the support structures.

8. The vibration assembly according to claim 1, wherein the magnet member comprises a central magnet and a magnetic conductive sheet, and the magnetic conductive sheet is arranged at a top end of the central magnet.

9. The vibration assembly according to claim 1, further comprising a bonding layer, wherein the diaphragm is connected to the connection part through the bonding layer.

10. The vibration assembly according to claim 1, wherein an inner surface of the bowl-shaped part of an outer first magnetic conductive layer of the first magnetic conductive layers is in contact with an outer surface of the bowl-shaped part of an inner first magnetic conductive layer of the first magnetic conductive layers.

11. A loudspeaker, comprising a vibration assembly, wherein the vibration assembly comprises:
a yoke structure, comprising a plurality of nested first magnetic conductive layers, wherein each of the first magnetic conductive layers comprises a bowl-shaped part and a connection part, the connection part is arranged at a top end of the bowl-shaped part and extends laterally outward to form an annular edge, the yoke structure is provided with a plurality of first through holes, and each of the first through holes penetrates the bowl-shaped parts of the plurality of first magnetic conductive layers;
a diaphragm, arranged at a top end of the yoke structure, wherein an edge of the diaphragm is connected to the connection part, and the diaphragm and the yoke structure define a cavity;
a magnet member, arranged at a bottom of the cavity, wherein an annular magnetic gap is formed between a side surface of the magnet member and the yoke structure; and
a voice coil, arranged in the annular magnetic gap, wherein a top end of the voice coil is connected to the diaphragm.

12. The loudspeaker according to claim 11, wherein sizes of the plurality of first magnetic conductive layers increase from inside to outside sequentially, and the plurality of first through holes are provided on the bowl-shaped parts in a matrix form.

13. The loudspeaker according to claim 11, wherein the yoke structure further comprises a second magnetic conductive layer, the second magnetic conductive layer has a bowl-shaped structure and is attached to an outer surface of the bowl-shaped part of the outermost first magnetic conductive layer, and the second magnetic conductive layer is provided with a plurality of second through holes corresponding to the plurality of first through holes.

14. The loudspeaker according to claim 11, wherein the yoke structure is provided with relief grooves, and the relief grooves penetrate the connection parts of the plurality of first magnetic conductive layers and enable an outside of the yoke structure to be in communication with the cavity.

15. The loudspeaker according to claim 14, wherein two sides of the voice coil are connected to wires, and the wires extend through the relief grooves.

16. The loudspeaker according to claim 15, further comprising a circuit board assembly that is arranged below the yoke structure and electrically connected to the wires.

17. The loudspeaker according to claim 16, further comprising support structures, wherein the support structures are arranged outside of the yoke structure, tops of the support structures extend into the relief grooves, bottoms of the support structures are connected to the circuit board assembly, and channels for accommodating the wires are provided inside the support structures.

18. The loudspeaker according to claim 11, wherein the magnet member comprises a central magnet and a magnetic conductive sheet, and the magnetic conductive sheet is arranged at a top end of the central magnet.

19. The loudspeaker according to claim 11, further comprising a bonding layer, wherein the diaphragm is connected to the connection part through the bonding layer.

20. The loudspeaker according to claim 11, wherein an inner surface of the bowl-shaped part of an outer first magnetic conductive layer of the first magnetic conductive layers is in contact with an outer surface of the bowl-shaped part of an inner first magnetic conductive layer of the first magnetic conductive layers.
